(19) United States
(12) Patent Application Publication
(10) Pub. No.: US 2026/0086925 A1
(43) Pub. Date: Mar. 26, 2026

(54) SYSTEMS AND METHODS FOR IMPROVING SELECTION OF CONTROL SET

(71) Applicant: FMR LLC, Boston, MA (US)

(72) Inventors: Saurav PATTNAIK, Kolar (IN); Sundarakumar KALAIMANI, Cumberland, RI (US)

(21) Appl. No.: 18/891,192

(22) Filed: Sep. 20, 2024

(51) Int. Cl. G06F 11/36

(52) U.S. Cl. CPC G06F 11/3684; G06F 11/368

(57) ABSTRACT

Systems and methods are described for improving the selection of one or more control sets based on a test set. More specifically, one or more match sets, each having one or more entities, are generated for the test entities in the test set. Then, an entity combination is generated for each possible combination of the entities in the one or more match sets. The entity combinations that are most similar to the test set are determined to be the control sets.

### TECHNICAL FIELD

This application relates generally to systems and methods, including computer program products, for improving the selection of one or more control sets based on a test set.

### BACKGROUND

It can be often difficult to determine whether an implementation of a new protocol (e.g., implementation of new technology) has a positive, neutral, or negative impact on an organization. This is because there are many existing variables that have constantly shifting values, which obscure the impact of such technology. For example, an organization may implement a new security software that is designed to better detect malicious emails at their offices in different locations. An assessment at a later time may indicate a decrease in the number of successful attacks since the implementation of the security software. However, such decrease may be the result of a variety of factors (or a combination of one or more factors), such as an effective employee training program to detect malicious emails, a reduction in the number of malicious actors (e.g., hackers) due to more stringent laws, or a new (or enhanced) security feature implemented by the vendor of the email service provider. In other words, it is difficult to determine whether the observed results were actually the consequence of implementing the protocol.

As such, a controlled experiment can be performed to conclude whether the implementation of the protocol actually resulted in the desired effect. In such controlled experiment, an attempt is made to ensure that all dependent variables in the experiment are constant, while the independent variable is allowed to change values. More specifically, the experiment involves providing one value for the independent variable (e.g., implementing the protocol) for members of a test group, while providing another (different) value for the independent variable (e.g., withholding the implementation of the protocol) for members of a control group. To ensure that the dependent variables remain constant, the members of the test group and the control group are selected such that these members have similar characteristics. Otherwise, by selecting members that each have different characteristics from each other, the wrong conclusions can be drawn from the experiment.

Nevertheless, as is known, constructing a control group is difficult. One reason is due to the technical limitation involving population size (e.g., number of office locations) from which to perform the selection. It is much easier to select a control group when the population size is large (e.g., in the millions) because there is a greater probability in finding constituents of the population that are similar to members in the testing group. Nevertheless, such task becomes more difficult when the population size is smaller (e.g., the organization may be a retail store having less than five hundred locations), in which there is a lesser probability in finding constituents of the population that are similar to members in the testing group. Indeed, the conventional means for selecting a control group, such as propensity score matching, caliper matching, and (k-) nearest neighbor matching all fail to produce an appropriate (or proper) control group when the population size is small, thereby leading to incorrect decisions being drawn from the experiment.

As such, there remains a need for a process to select a control group having members that have similar characteristics to members of the test group when the population size (from which to select the members) is small.

### SUMMARY

The present disclosure, in one aspect, features a computing (or computer) system for improving the selection of one or more control sets based on a test set, the system comprising a server computing device having a memory for storing computer-executable instructions and a processor that executes the computer-executable instructions to: retrieve entities associated with an entity unit after receiving instructions to generate the one or more control sets based on the test set, wherein the test set includes one or more test entities that correspond to respective entities in the entity unit; determine one or more match sets for the test entities in the test set, wherein each match set includes a predetermined number of entities in the entity unit that are determined to be most similar to a corresponding test entity,
the determination of a match set for each test entity comprising: generating an entity score for each entity in the entity unit, wherein the entity score is generated based on entity attributes associated with the entity and test attributes associated with the test entity; and generating the match set based on predetermined number of entities that have leading entity scores; remove entities in each of the match set that correspond to a test entity in the test set and that are duplicates of entities in other match sets, such that the one or more match sets includes entities that are unique; generate one or more entity combinations based on the entities in the one or more match sets, wherein the one or more entity combinations include one or more possible combinations of the entities in the one or more match sets; generate a combination score for each entity combination, wherein each combination score is generated based on combination attributes associated with the entity combination and test set attributes associated with the test entity; generate the one or more control sets based on predetermined number of entities that have leading combination scores; and display, on a user interface, the one or more control sets including the entities that are included in each of the one or more control sets.

The instructions to generate the one or more control sets based on the test set are provided by a user via a user interface that is configured to receive instructions to customize the generating of a control set based on one or more selections by the user. 3. The user interface is configured to allow a user to select one or more attributes corresponding to each of the one or more entities, and wherein selected attributes are utilized in determining the entities to be included in the one or more control sets and unselected attribute are not utilized in determining the entities to be included in the one or more control sets. The user interface is configured to allow a user to determine an attribute importance level with respect to each selected attribute, the attribute importance level determining the weight that the corresponding attribute has on determining the entities to be included in the one or more control sets. The user interface is configured to allow a user to select a time period in connection with the one or more attributes, and wherein a value corresponding to each of the one or more attributes is an average value generated based on the time period. The user interface is configured to allow a user to select one or more filters, and wherein each of the one or more filters removes one or more entities from the entity unit that violate criteria corresponding to the filters. The user interface is configured to allow a user to select the number of control sets to generate based on the test set.

The present disclosure, in another aspect, features a non-transitory computer-readable medium including computer-executable instructions that, when executed by a computing device, causes the computing device to: retrieve entities associated with an entity unit after receiving instructions to generate one or more control sets based on a test set, wherein the test set includes one or more test entities that correspond to respective entities in the entity unit; determine one or more match sets for the test entities in the test set, wherein each match set includes a predetermined number of entities in the entity unit that are determined to be most similar to a corresponding test entity, the determination of a match set for each test entity comprising: generating an entity score for each entity in the entity unit, wherein the entity score is generated based on entity attributes associated with the entity and test attributes associated with the test entity; and generating the match set based on predetermined number of entities that have leading entity scores; remove entities in each of the match set that correspond to a test entity in the test set and that are duplicates of entities in other match sets, such that the one or more match sets includes entities that are unique; generate one or more entity combinations based on the entities in the one or more match sets, wherein the one or more entity combinations include one or more possible combinations of the entities in the one or more match sets; generate a combination score for each entity combination, wherein each combination score is generated based on combination attributes associated with the entity combination and test set attributes associated with the test entity; generate the one or more control sets based on a predetermined number of entities that have leading combination scores; and display, on a user interface, the one or more control sets including the entities that are included in each of the control sets.

The entity score is determined based at least in part on selected attributes, which are attributes that are utilized in determining the one or more control sets. The entity score is represented by the following equation:

$$entity score = {\sum }_{k = 1}^{n} attribute {{weight}_{k} ( \frac{test {attribute}_{k}}{entity {attribute}_{k}} - 1 )}^{2} \qquad ( 1 )$$

where n represents the number of selected attributes. The entities in the entity unit are arranged based on their respective entity scores, in which a predetermined number of entities having the lowest entity scores are included in a match set. The combination score is determined based at least in part on selected attributes, which are attributes that are utilized in determining the one or more control sets. The source urgency value is represented by the following equation:

$$combination score = {\sum }_{k = 1}^{n} attribute {{weight}_{k} ( \frac{test set {attribute}_{k}}{combination {attribute}_{k}} - 1 )}^{2} \qquad ( 2 )$$

where n represents the number of selected attributes. The one or more entity combinations are arranged based on their respective combination scores, in which a predetermined number of entity combinations having the lowest combination scores are included in a control set.

The present disclosure, in another aspect, features a computerized method for validating the qualifications of an entity to prevent fraud, the method comprising: retrieving entities associated with an entity unit after receiving instructions to generate the one or more control sets based on the test set, wherein the test set includes one or more test entities that correspond to respective entities in the entity unit; determining one or more match sets for the test entities in the test set, wherein each match set includes a predetermined number of entities in the entity unit that are determined to be most similar to a corresponding test entity, the determination of a match set for each test entity comprising: generating an entity score for each entity in the entity unit, wherein the entity score is generated based on entity attributes associated with the entity and test attributes associated with the test entity; and generating the match set based on predetermined number of entities that have leading entity scores; removing entities in each of the match set that correspond to a test entity in the test set and that are duplicates of entities in other match sets, such that the one or more match sets includes entities that are unique; generating one or more entity combinations based on the entities in the one or more match sets, wherein the one or more entity combinations include one or more possible combinations of the entities in the one or more match sets; generating a combination score for each entity combination, wherein each combination score is generated based on combination attributes associated with the entity combination and test set attributes associated with the test entity; generating the one or more control sets based on predetermined number of entities that have leading combination scores; and displaying, on a user interface, the one or more control sets including the entities that are included in each of the one or more control sets.

Each control set of the one or more control sets is associated with control set attributes, each control set attribute of a control set being associated with one or more control set attribute values that correspond to one or more points in time. Each test set attribute is associated with one or more test set attribute values that correspond to the one or more points in time, and wherein each test set attribute corresponds to a respective control set attribute. The method further comprises: generating an analysis set that includes a graphical analysis for each attribute that corresponds to a test set attribute and a control set attribute, wherein the analysis set is generated based on the test set attributes and the control set attributes, and wherein a graphical analysis of a specific attribute visually indicates the control set attribute values and the test set attribute values over a time period associated with the one or more points in time. The method further comprises: displaying one or more graphical analyses in the analysis set upon receiving instructions from a user. The graphical analysis is at least one of a line graph, a bar chart, a pie chart, and a scatter plot.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for improving selection of a control set.

FIG. 2 is a system flow diagram for improving selection of a control set.

FIG. 3 is a flow diagram of a computerized method for generating a control set.

FIG. 4A is an example diagram illustrating an entity unit having multiples entities, in which one or more entities are included in an entity group or test set.

FIG. 4B is an example diagram illustrating an entity unit having multiples entities, in which one or more entities are included in an entity group or test set, according to another embodiment.

FIG. 5A is an example diagram illustrating a user interface for setting parameters for generating a control set based on a test set.

FIG. 5B is an example diagram illustrating a user interface for setting parameters for generating a control set based on a test set, according to another embodiment.

FIG. 6A is an example diagram of a table indicating scores determined for entities based on how similar the attributes for each entity are with respect to a test entity.

FIG. 6B is an example diagram of a table indicating top entities that are determined to be most similar to the respective test entities.

FIG. 6C is an example diagram of a table indicating combination attributes for each attribute of entities in a match set.

FIG. 6D is an example diagram of a table indicating combination attributes for each attribute of entities in a test set.

FIG. 6E is an example diagram of a table indicating a combination score determined for each entity combination with respect to an entity group.

FIG. 7 is an example diagram of a user interface displaying results for generating a control set based on the test set.

FIG. 8 is a stage flow diagram of a computerized method for generating a control set.

FIG. 9A is an example diagram of a graphical analysis of the test set and associated control sets with respect to a first attribute.

FIG. 9B is an example diagram of a user interface displaying a graphical analysis of the test set and associated control sets with respect to a second attribute.

FIG. 10 is a diagram of an illustrative computing system.

### DETAILED DESCRIPTION

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools are discussed herein to facilitate the invention(s) disclosed herein. It should be appreciated by those skilled in the art that any one or more of such tools may be embedded in the application and/or in any of various other ways, and thus while various examples are discussed herein, the inventive aspects of this disclosure are not limited to such examples described herein.

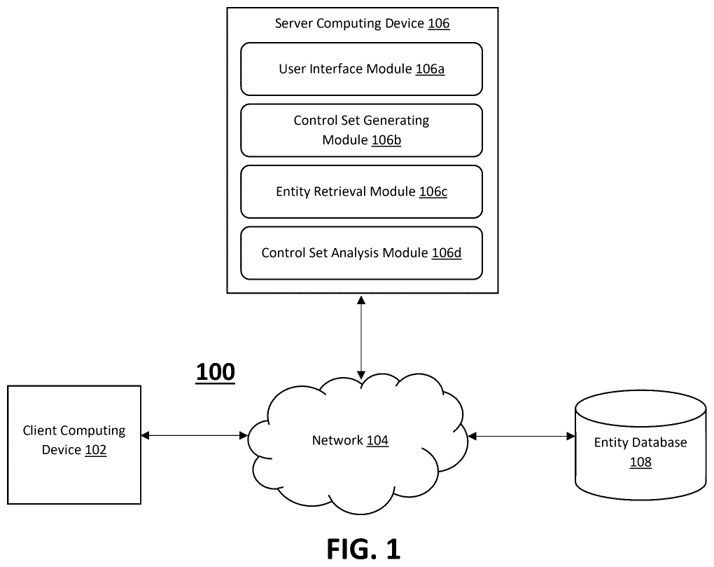

FIG. 1 is a block diagram of a system for 100, which includes a client computing device 102, a server computing device 106, and an entity database 108, all of which are capable of communicating with each other via a communication network 104.

The client computing device 102 can be coupled to a display device (not shown), such as a monitor, display panel, or screen. For example, client computing device 102 can provide a graphical user interface (GUI) via the display device to a user of corresponding device that presents output resulting from the methods and systems described herein and receives input from the user for further processing. Further, the client computing device 102, may include one or more applications that provide additional functionality to the client computing device 102. For example, the client computing device 102 may include a browser application that allows access to the services provided by devices on system 100, via a website, which can be reached by entering a uniform resource locator (URL). Exemplary client computing device 102 include but is not limited to desktop computers, laptop computers, tablets, mobile devices, smartphones, smart watches, Internet-of-Things (IoT) devices, and internet appliances. It should be appreciated that other types of client computing devices that are capable of connecting to components of the system 100 can be used without departing from the scope of invention. Although FIG. 1 depicts a single client computing device 102, it should be appreciated that system 100 can include any number of client computing devices 102.

The communication network 104 can be a local area network, a wide area network, a cellular network, or any type of network such as an intranet, an extranet (for example, to provide controlled access to external users, for example through the Internet), a private or public cloud network, the Internet, etc., or a combination thereof. In addition, the communication network 104 preferably uses TCP/IP (Transmission Control Protocol/Internet Protocol), but other protocols such as SNMP (Simple Network Management Protocol) and HTTP (Hypertext Transfer Protocol) can also be used. In some embodiments, the communication network 104 is comprised of several discrete networks and/or sub-networks (e.g., cellular to Internet).

The server computing device 106 is a device including specialized hardware and/or software modules that execute on a processor and interact with memory modules of the server computing device 106, to transmit data to other components of the system 106, and to receive data from other components of the system 100, as described herein. The server computing device 106 includes several systems, frameworks, stores, and computing modules that execute on one or more processors of the server computing device 106. For example, the server computing device 106 includes a user interface module 106a, a control set generating module 106b, an entity retrieval module 106c, and a control set analysis module 106d. In some embodiments, the user interface module 106a, the control set generating module 106b, the entity retrieval module 106c, and the control set analysis module 106d are specialized sets of computer software instructions programmed onto one or more dedicated processors in server computing device 106 and can include specifically-designated memory locations and/or registers for executing the specialized computer software instructions.

Although the user interface module 106a, the control set generating module 106b, the entity retrieval module 106c, and the control set analysis module 106d are shown in FIG. 1 as executing within the same server computing device 106, in some embodiments the functionality of the user interface module 106a, the control set generating module 106b, the entity retrieval module 106c, and the control set analysis module 106d can be distributed among a plurality of server computing devices. As shown in FIG. 1, the server computing device 106 allows the user interface module 106a, the control set generating module 106b, the entity retrieval module 106b, and the control set analysis module 106d to communicate with each other in order to exchange data for the purpose of performing the described functions.

It should be appreciated that any number of computing devices, arranged in a variety of architectures, resources, and configurations (e.g., cluster computing, visual computing, cloud computing) can be used without departing from the scope of the invention. Exemplary functionality of the user interface module 106a, the control set generating module 106b, the entity retrieval module 106c, and the control set analysis module 106d are described in detail below.

The entity database 108 is a computing device (or, in some embodiments, may be a set of computing devices) that is configured to provide, receive and/or store various types of entity units. More specifically, an entity unit may include one or more entities that each may be a person, place, thing, or concept. In addition, one or more entities may be grouped into an entity group based on one or more criteria. In some embodiments, all or a portion of the entity database 108 is accessible via the communication network 104. In addition, it should be noted that the entity database 108 may be encrypted to prevent data from being compromised.

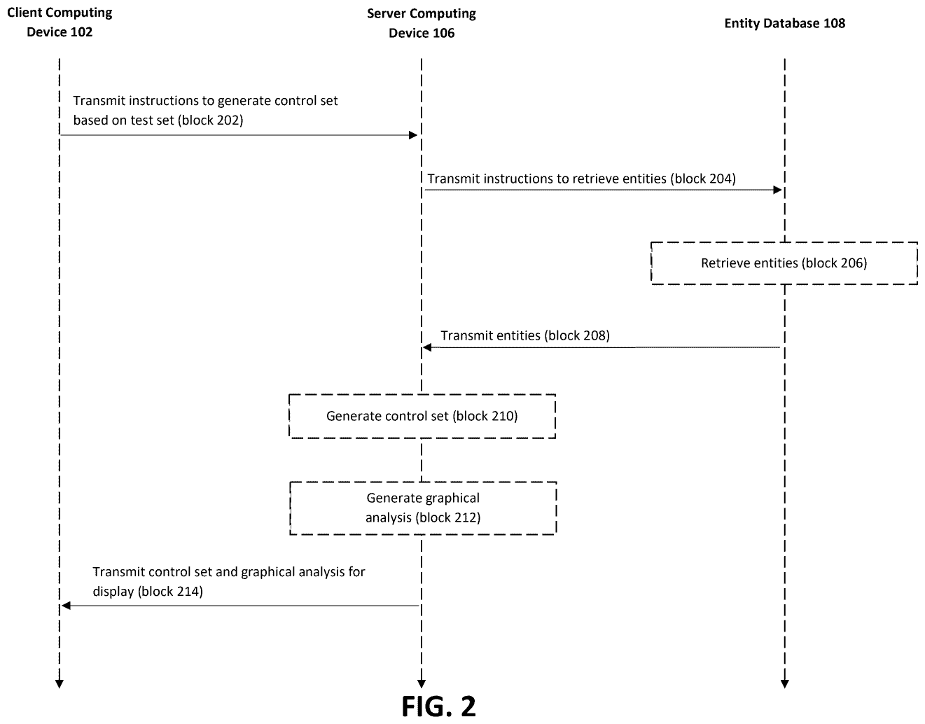

FIG. 2 illustrates an exemplary flow diagram corresponding to the system 100 of FIG. 1, in which the client computing device 102, the server computing device 106, and the entity database 108, communicate with each other to perform one or more actions. At block 202, the client computing device 102 transmits instructions (to the server computing device 106) to generate a control set(s) based on a test set, in which the test set includes one or more entities selected, for example, by a user. At block 204, the server computing device 106 transmits instructions (to the entity database 108) to retrieve entities from the entity database 108. At block 206, the entity database 108 retrieves the entities as requested by the server computing device 106. At block 208, the entity database 108 transmits entities to the server computing device 106. At block 210, the server computing device generates a control set based on the entities received from the entity database 108. At block 212, the server computing device generates a graphical analysis (e.g., based on the test set and/or control set). At block 214, the server computing device 106 transmits the control set and the graphical analysis to the client computing device 102.

### Example Routine for Generating Control Set

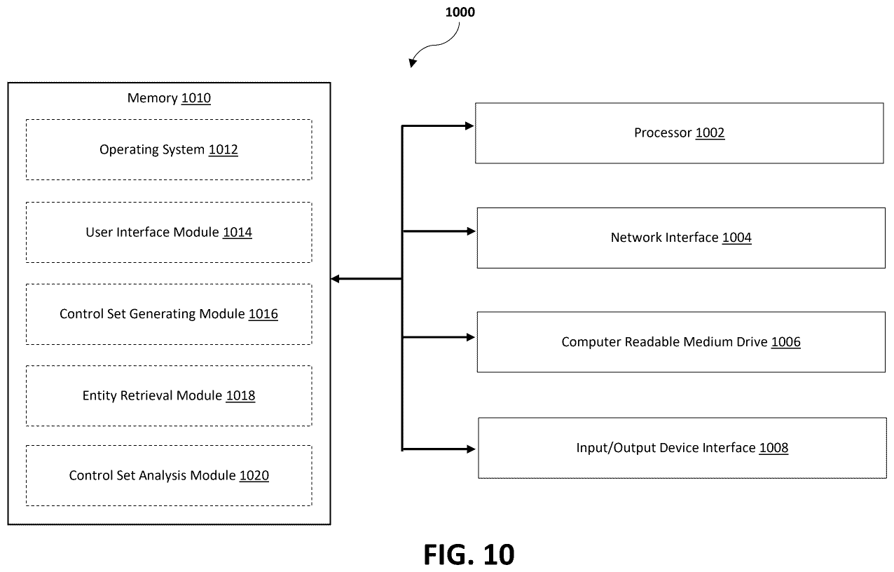

When a routine described herein (i.e., 300) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1000 shown in FIG. 10, and executed by one or more processors. In some embodiments, the routine 300, or portions thereof may be implemented on multiple processors, serially or in parallel.

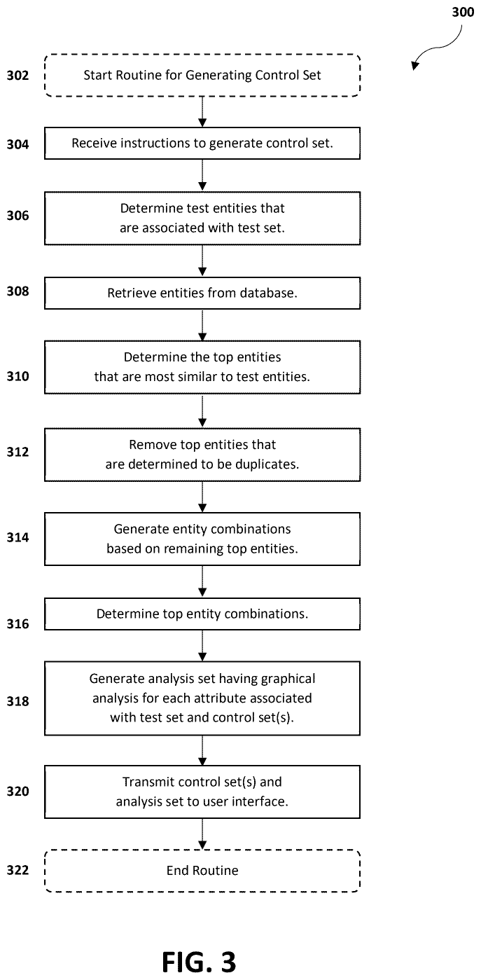

FIG. 3 illustrates example routine 300 (beginning at block 302) for generating a control set, that is performed, for example, by the server computing device 106. At block 304, the control set generating module 106b of the server computing device 106 receives instructions to generate a control set. In some embodiments, the server computing device 106 may receive the instructions from a user via a user interface provided by the user interface module 106a to the client computing device 102. For example, the user may be performing an experiment (e.g., implementing a new protocol or technology) in which the user is attempting to determine the effects of an experimental variable upon an entity group (e.g., person, organization, computing system, software, market). In some embodiments, the experimental variable may be an existing variable in the test set. In other embodiments, the experimental variable may be a new variable introduced into the test set.

However, the entities (e.g., cells of a person's body, humans in a population, offices or locations in an organization, employees of an organization, components of a computer, modules in a software, branches of an organization organized by market) that constitute such entity group may not necessarily have similar attributes (e.g., properties or characteristics). This poses a problem because the entities can each diminish or amplify the effects of the experimental variable thereby causing an inaccurate conclusion to be drawn from the experiment. To ensure that the experiment provides accurate conclusions, the user may perform the experiment using a test set and a control set. The test set may comprise test entities, each of which may include one or more entities from the entity group on which the user is attempting to determine the effects of the experimental variable. The control set may include control entities that are selected based on how similar their attributes are to the entities in the test set.

For example, the entity unit may be an organization (which may have many offices in various geographical areas), the entities may be devices (e.g., computers, smartphones, routers) in use by the organization, the entity group may be a specific office of an organization, the test entities may be all of the devices (or a subset (e.g., one or more) of the devices (e.g., smartphones)) of the specific office (e.g., entity group), and the control entities may be devices from offices (in the organization) other than the specific office. In another example, the entity unit may be an organization (which may have many branches), the entities may be branches (e.g., offices, retail locations, etc.) of an organization, the entity group may be entities that are associated with a specific market (e.g., an organization may determine a market as a region in which goods and services are bought, sold, or used or may determine a market as a body of existing or potential buyers for specific goods or services), the test entities may be all of the branches (or may be a subset (e.g., one or more) of the branches) of the organization associated with the specific market (e.g., entity group), and the control entities may be other branches (e.g., not of the same market) associated with the organization.

In a further example, the entity unit may be a computing system, the entities may be components (e.g., memory, power supply, processor, hard drive, fan, motherboard, wires, graphics card, etc.) of the computing system, the entity group may a grouping of the components by a specific functionality (e.g., processing, data storage, power management), the test entities may be all of the components (or a subset (e.g., one or more) of the components) of entity group, and the control entities may be components that offer a similar functionality to the functionality associated with the entities in the test set. It should be noted that from the aforementioned examples, an entity unit (e.g., organization) may have different types of entities (e.g., employees, electronic components, computing devices, equipment, etc.) that are associated with such entity unit.

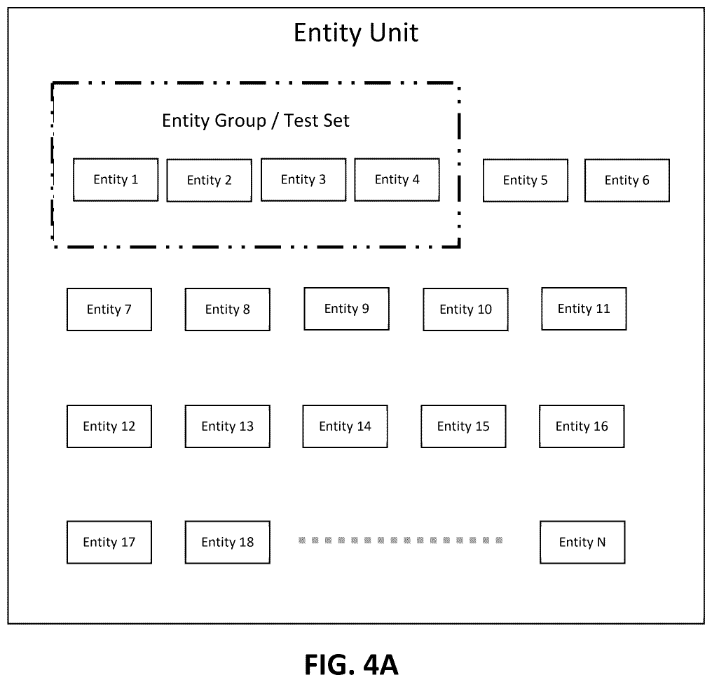

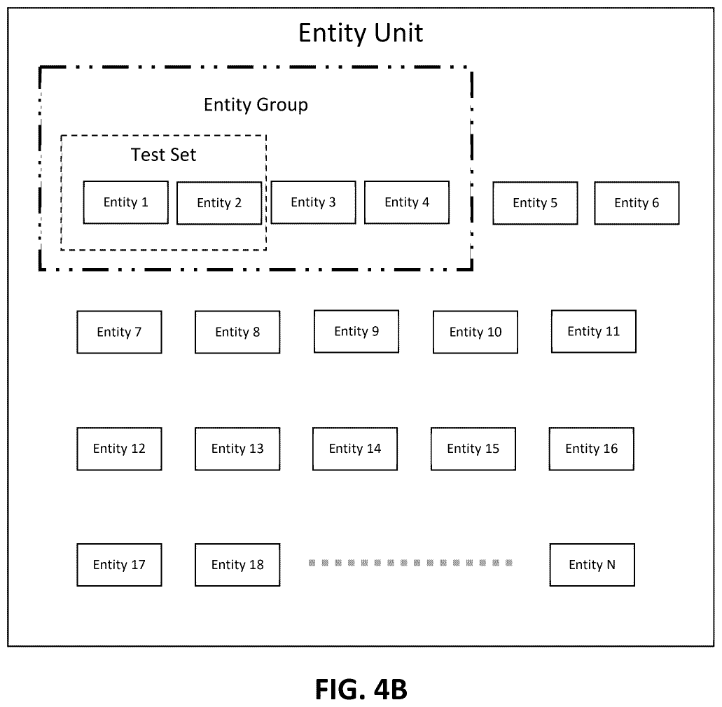

FIG. 4A illustrates a diagram of an entity unit that includes multiple entities 1-N, in which N may be a positive integer. As shown, one or more of the entities 1-N may be grouped into an entity group (e.g., “Entity 1”, “Entity 2”, “Entity 3”, “Entity 4”). Likewise, the test set may also include the same entities that are in the entity group. FIG. 4B illustrates another diagram of an entity unit that includes multiple entities 1-N, in which in which N may be a positive integer. As shown, one or more of the entities 1-N may be grouped into an entity group. However, in contrast with the diagram in FIG. 4A, the test set includes a portion (e.g., “Entity 1”, “Entity 2”) of the entity group. It should be noted that, while FIGS. 4A and 4B illustrate a single entity group, each of the other remaining entities 5-N may be grouped into another entity group as well. In such case, the entity unit may include two or more entity groups.

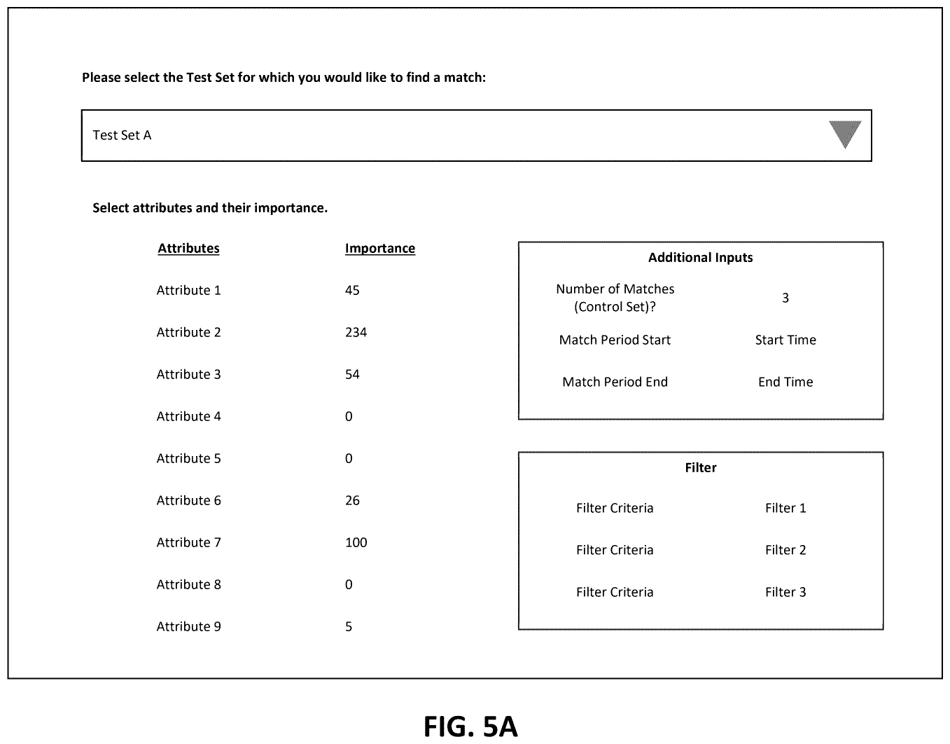

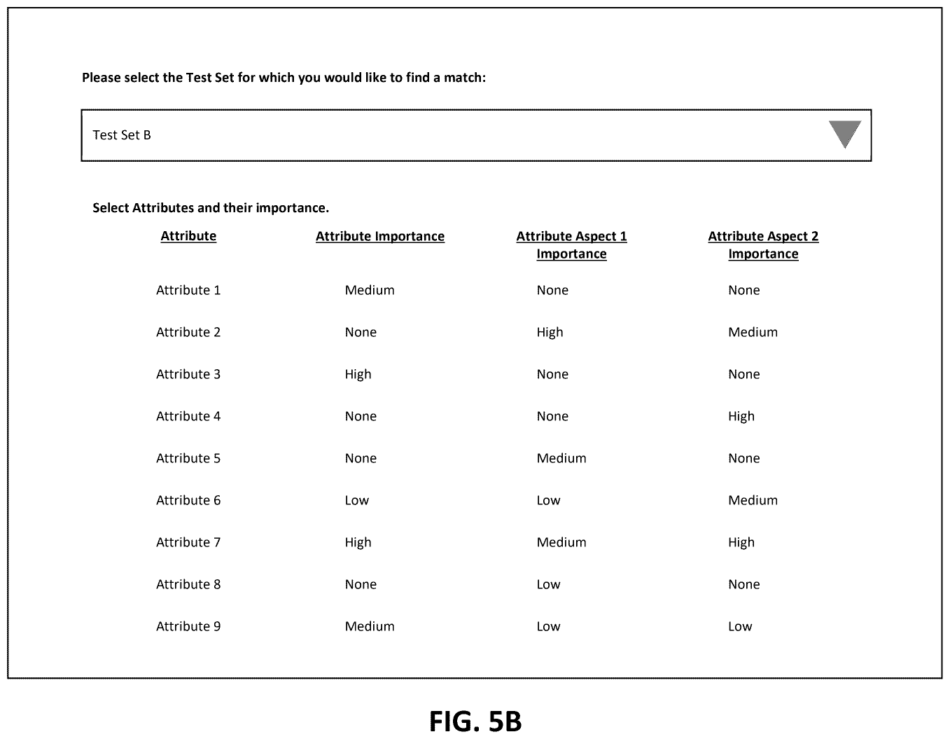

FIG. 5A illustrates an example of a user interface (e.g., provided by the user interface module 106a) that may be used to receive instructions input by the user. For example, the user may use the user interface to customize the process for generating the control set (e.g., based on one or more selections made by the user). As shown, the user may select a test set (e.g., “Test Set A”), which may form the basis of generating the control set. In some embodiments, the user may upload the test set as a file from the client computing device 102. In other embodiments, the server computing device 106 may provide the test set as one of many pre-selected options. In addition, the user may also select the attributes, which may be used as one of the factors in selecting the control set. The attributes may be characteristics or properties that are associated with each entity of the entity unit. In some embodiments, each of the entities in the entity unit have the same attributes as each other.

For example, the entity unit may be a bank that provides retail banking services via branches throughout the nation. As such, each of the branches may include attributes such as the number of banking representatives employed at the branch, the amount of assets managed by the branch, information regarding customers who are served by the branch (e.g., average household size, average age, etc.), equipment (e.g., computing devices, smartphones, printers, copiers, fax machines, cash bill counting machines) used by the branch, rent paid by the branch, the physical size of the space occupied by the branch, the neighborhood in which the branch is located, geography associated with the branch, etc.

The user may be provided with an option to determine an attribute importance level. The attribute importance level may determine how important (e.g., weighted) the attribute is when determining the control set. A higher value means that the attribute should be provided more weight when determining the control set, and a lower value means that the attribute should be provided less weight when determining the control set. In some embodiments, the user may input a numerical value for each attribute. A value of zero for the attribute importance level may indicate that the corresponding attribute is not to be considered when determining the control set. A value greater than zero (e.g., 1, 3, 100) for the attribute importance level may indicate that the corresponding attribute has weight (the significance of which corresponds to the value input by the user) in determining the control set. It should be noted that the value for the attribute importance level may also be a percentage as well. In other embodiments, the user may input a set of options (e.g., none, low, medium, high) that correspond to a different predetermined weight. By selecting “none,” the corresponding attribute may not be used for determining the control set. Otherwise, by selecting one of the other attribute importance levels (e.g., low, medium, high), the user is indicating that the control set is to be generated using such attribute. As discussed, such weight may correspond to a predetermine weight, such as a numerical unit (e.g., none=0, low=10, medium=50, high=150), that determines how much impact the attribute has on determining the control set. An example of such configuration is shown in FIG. 5B.

In addition, the user interface also allows a user to select the number of control sets to generate (“Number of Matches (Control Set)?”). In this example, the user has selected to generate three control sets. Further, the user interface also allows the user to input a time period, which includes a starting time (“Match Period Start”) and an ending time (“Match Period End”). More specifically, the values of the attribute (e.g., average household size, average number of representatives) may change from time to time. As such, the time period input by the user may determine the timeframe from which to determine the value (or measurement) of the attribute. For example, the value of the attribute may be determined based on the average value of the attribute over the specified time period. Further, the user interface also allows the user to input one or more filter criteria, which has an impact on which entities are used for determining the control set. For example, in the case that the entity unit was a bank with an international presence, the user may select to filter out any foreign branches in favor or domestic banks.

FIG. 5B is an example of a user interface (e.g., provided by the user interface module 106a), according to another embodiment, that allows the user to input instructions for determining a control set. More specifically, the user interface allows the user to further specify the importance levels associated with aspects of an attribute (e.g., attribute aspect) so as to indicate nuances among the entities. Such nuances may be an important factor in the process of determining the control entities in the control set. For example, the entity unit may be a financial organization that includes one or more branch offices (e.g., entities) that each manage multiple customers. An exemplary attribute that is associated with such financial organization may be total balances of customers managed by the branch. As such, like previously with respect to FIG. 5A, the user can select the importance level of the attribute (e.g., total (monetary) balances of customers managed by the branch). However, the user can also further specify the importance level of one or more aspects associated with the attribute.

As shown in FIG. 5B, the user can specify an importance level of an attribute aspect 1 and an attribute aspect 2. For example, the attribute aspect 1 may correspond to total balances held by each representative of the branch (e.g., each representative is responsible for managing the balances of one or more customers). Such aspect is significant because there can be a first branch that includes ten representatives and a second branch that includes fifty representatives, in which both the first branch and the second branch having similar number of customers with comparable balances. In another example, the attribute aspect 2 may correspond to average total balances of customers of the branch. Such aspect is significant because it would help in comparing the differences in customer wealth within that branch.

At block 306, the control set generating module 106b determines the test entities that are associated with the test set. For example, the test set may include one or more test entities that correspond to entities that are included in the entity unit. At block 308, the control set generating module 106b may retrieve entities from the entity database 108. In some embodiments, the control set generating module 106b may instruct the entity retrieval module 106c to retrieve or obtain entities from the entity database 108. It should be noted that the entity database 108 may include one or more entity units. As such, the control set generating module 106b or the entity retrieval module 106c may select to obtain entities included in an entity unit that is associated with the test entities in the test set. Each entity in the entity database 108 may be associated with entity information (e.g., name of entity, attributes of entity, etc.). Further, it should also be noted that, as discussed previously with respect to FIGS. 4A and 4B, the retrieved entities (corresponding to the entity unit associated with the test entities in the test set) may also include the test entities of the test set. This is because the test entities in the test set may not be necessarily separate entities from the entities in the entity unit, but are designated as “test” entities for the purposes of determining the control set.

At block 310, the control set generating module 106b determines the top entities that are most similar to the test entities. More specifically, the control set generating module 106b may determine the top entities that have the most similar attributes to each of the test entities in the test set. A match set may include one or more predetermined number of top entities that are determined to be most similar to a specific test entity. In some embodiments, the number of top entities is a predetermined number (e.g., top 1, 2, 3, 4, 5, 6, or 7 entities). In other embodiments, the number of top entities is a number determined by the user via a user interface provided by the user interface module 106a. As stated previously, the control set generating module 106b determines the top entities for each test entity in the test set. Such determination is achieved by generating an entity score for each entity with respect to a specific test entity. For example, the control set generating module 106b may determine an entity score based on the following equation:

$$entity score = {\sum }_{k = 1}^{n} attribute {{weight}_{k} ( \frac{test {attribute}_{k}}{entity {attribute}_{k}} - 1 )}^{2} \qquad ( 1 )$$

In some embodiments, the variable n represents the number of attributes that are included in the test entity. In other embodiments, the variable n corresponds to the number of attributes that the user has selected to determine the control set. As discussed previously with respect to FIGS. 4A and 4B, the user may select one or more attributes via a user interface provided by the user interface module 106c. It should be noted that the types of attributes in the test entity and the entity are assumed to be the same. However, in cases in which one or more attributes exist in the test entity and not in the entity or vice versa, it may be that such attributes are not considered in the determination of the control set. It should also be noted that a specific attribute may be the same scale or same SI unit (Système international d'unités) for each of the entities (e.g., an attribute identifying the number of computers is measured the same way (integer format) for each entity or an attribute identifying the average salary of employees at a branch office is measured the same way (U.S. dollars and not another currency) for each entity).

Further, each term in the summation of equation (1) is based on a test attribute, which is a single attribute of the test entity (e.g., number of electronic devices at a branch office that is part of the test set), and an entity attribute, which is a corresponding single attribute of the entity (e.g., number of electronic devices associated with another branch office). In addition, each term also includes an attribute weight, which determines the significance (e.g., weight) of the attribute in determining the entity score. For example, as discussed previously with respect to FIG. 5A, the user may select the attribute importance level (e.g., a set of predetermined options (e.g., low, medium, high) or a numerical value) in the user interface provided by the user interface module 106a. As such, the attribute importance level may determine (or be equivalent to) the attribute weight.

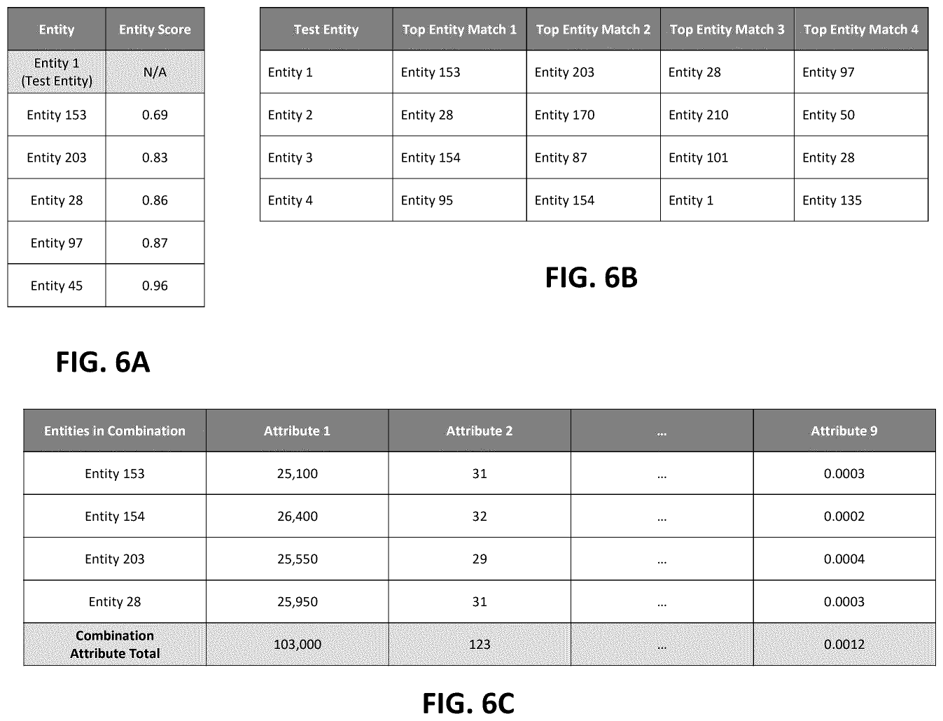

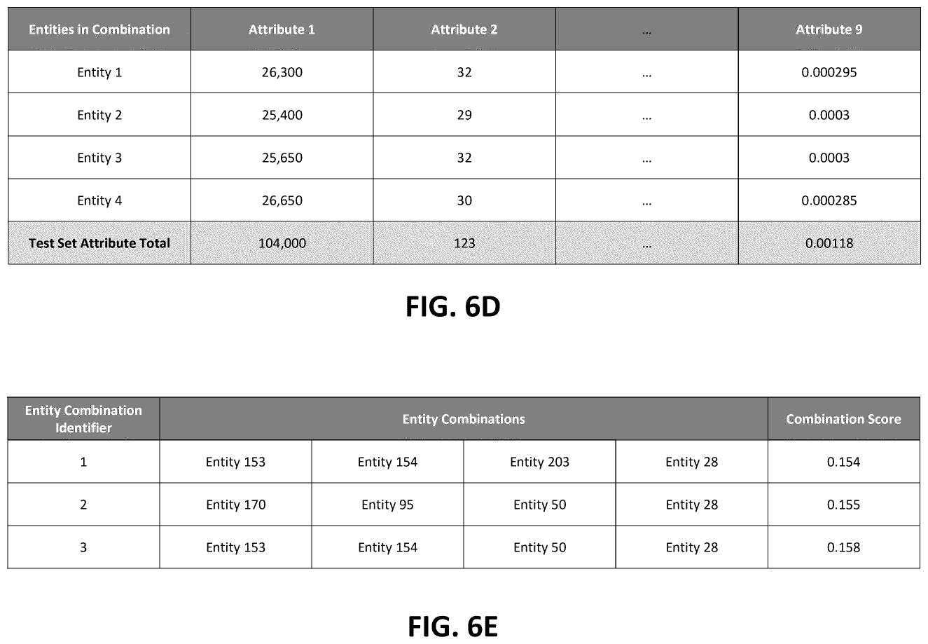

FIG. 6A illustrates an example of a table showing multiple entities having corresponding entity scores that are determined based on a specific test entity (e.g., “Entity 1”). As discussed previously, an entity score indicates how similar an entity is with respect to the test entity. In some embodiments, the entity score may have been determined using equation (1). As shown, the lower the entity score, the more similar the corresponding entity is with respect to the test entity (e.g., “Entity 153” is determined to be relatively more similar to “Entity 1” than “Entity 45”). FIG. 6B illustrates an example of a table showing each test entity of the test set that is associated with a match set that includes a predetermined number (e.g., 1, 2, 3, 4, 5) of top entities that are determined to be the most similar to each test entity.

At block 312, the control set generating module 106b removes top entities that are determined to be duplicates. More specifically, as shown in FIG. 6B, the first test entity (“Entity 1”) includes one or more entities in its match set that are present in the match set of the other entities. For example, “Entity 28” is in both the match set corresponding to “Entity 1” and “Entity 2”. In another example, “Entity 154” is in both the match set corresponding to “Entity 3” and “Entity 4.” As such, the control set generating module 106b removes duplicates from each of the match sets (e.g., remove “Entity 28” from “Entity 2”). In some embodiments, the control set generating module 106b may perform such removal starting from the “Entity 2” and moving towards “Entity 4.” In addition, as is also shown in FIG. 6B, the match set corresponding to “Entity 4” includes “Entity 1”, which is a test entity. As such, the control set generating module 106b removes “Entity 1” from the match set corresponding to “Entity 4”. In other words, the control set generating module 106b removes any test entity that is found in a match set corresponding to a test entity.

At block 314, the control set generating module 106b generates entity combinations based on the remaining top entities. More specifically, each of the entity combinations may be a mathematical combination (combinatory logic), which is the combination of n top entities taken k at a time without repetition. In this case, the pool of n entities corresponds to the remaining entities in the match sets and k is the combination size. In some embodiments, the combination size is a number equivalent to the predetermined number of entities in a match set. In other words, a match set and the entity combination should have the same number of entities. In other embodiments, the combination size is a predetermined number that is different from the predetermined number of entities in the match set. In further embodiments, the user may input the combination size via the user interface provided by the user interface module 106a. In yet further embodiments, the number of entities in the test set, the number of entities in a single match set, and the number of entities in a single entity combination are the same (predefined) number. The standard notation for a mathematical combination may be represented by C(n, k), ₙCₖ, or

$$( \begin{matrix}n \\ k\end{matrix} ) .$$

At block 316, the control set generating module 106b determines the top entity combinations. More specifically, the control set generating module 106b may determine the top entity combinations that are most similar to the test set (e.g., as a whole). In some embodiments, the number of top entity combinations is a predetermined number (e.g., top 1, 2, 3, 4, 5, 6, or 7 entities). In other embodiments, the number of top entities is a number determined by the user via a user interface provided by the user interface module 106a, as previously shown in FIG. 5A (e.g., “Number of Matches (Control Set)?”). The determination of the top entity combinations may be achieved by generating a combination score for each entity combination with respect to the test set (or, in the alternative, corresponding entity group). For example, the control set generating module 106b may determine a combination score based on the following equation:

$$combination score = {\sum }_{k = 1}^{n} attribute {{weight}_{k} ( \frac{test set {attribute}_{k}}{combination {attribute}_{k}} - 1 )}^{2} \qquad ( 2 )$$

In some embodiments, the variable n represents the number of attributes that are included in the entities in the entity unit (e.g., test entity). In other embodiments, the variable n corresponds to the number of attributes that the user has selected to determine the control set. As discussed previously with respect to FIGS. 4A and 4B, the user may select one or more attributes via a user interface provided by the user interface module 106c. It should be noted that the types of attributes for each entity (e.g., test entity) in the entity unit are assumed to be the same. However, in cases in which there are different attributes among the entities in the entity unit, it may be that such attributes are not considered in the determination of the control set.

Each term in the summation of equation (2) is based on a test set attribute and a combination attribute. To generate combination attributes, the control set generating module 106b determines a total value for each attribute in the entity combination. For example, as shown in the table in FIG. 6C, an entity combination may include “Entity 153”, “Entity 154”, “Entity 203”, and “Entity 28” which are each associated with “Attributes 1-3, 6, 7, and 9” (e.g., as selected by the user for determining the control set in the user interface shown in FIG. 5A). As such the values associated with attribute 1 for each of the entities in the entity combination (e.g., “25,100”, “26,400”, “25,550”, and “25,950”) are summed or totaled together to generate a combination attribute (e.g., “103,000”). Likewise, the same action is performed with respect to the remaining attributes (e.g., “Attributes 2, 3, 6, 7, and 9”) to generate the other combination attributes.

Similarly, to generate the test set attributes, the control set generating module 106b determines a total value for each attribute in the test set. For example, as shown in the table in FIG. 6D, the test set may include “Entity 1”, “Entity 2”, “Entity 3”, and “Entity 4” which are each associated with “Attributes 1-3, 6, 7, and 9” (e.g., as selected by the user for determining the control set in the user interface shown in FIG. 5A). As such the values associated with attribute 1 for each of the entities in the test set (e.g., “26,300”, “26,400”, “25,650”, and “26,650”) are summed or totaled together to generate a test set attribute (e.g., “104,000”). Likewise, the same action is performed with respect to the remaining attributes (e.g., “Attributes 2, 3, 6, 7, and 9”) to generate the other test set attributes. It should be noted that in some embodiments, the test set attribute may be substituted with an entity group attribute, in which the attributes of the entity group (which may include the test set) are used in determining the combination score. In such case, the method of determining the entity group attribute is similar to the method for determining the test set attribute, in which the attributes (e.g., selected by the user in FIG. 5A) for each entity in the entity group are summed or totaled to generate an entity group attribute corresponding to each attribute (e.g., selected by the user). In addition, each term also includes an attribute weight, which determines the significance (e.g., weight) of the attribute in determining the combination score. For example, as discussed previously with respect to FIG. 5A, the user may select the attribute importance level (e.g., a set of predetermined options (e.g., low, medium, high) or a numerical value) in the user interface provided by the user interface module 106a. As such, the attribute importance level may determine (or be equivalent to) the attribute weight.

After generating a combination score for each entity combination, the control set generating module 106b determines a number of top entity combinations. For example, FIG. 6A illustrates an example of a table showing multiple entity combinations having corresponding entity scores that are determined based on a specific test entity (e.g., “Entity 1”). As discussed previously, a combination score indicates how similar an entity combination is with respect to the test set. In some embodiments, the combination score may have been determined using equation (2). As shown, the lower the combination score, the more similar the corresponding entity combination is with respect to the test entity (e.g., “Combination 1” is determined to be relatively more similar to the test set than “Combination 2” or “Combination 3”). As such, each of the top entity combinations is designated or considered to be a control set.

At block 318, the control set analysis module 106d generates an analysis set having a graphical analysis for each attribute associated with the test set and associated control sets. More specifically, the control set analysis module 106d may determine information on the entities in the test set and the control sets (e.g., test entities and control entities), such as one or more test set attributes and one or more combination (or control set) attributes. In some embodiments, the control set analysis module 106d may automatically retrieve such information from the control set generating module 106b. In other embodiments, the control set generating module 106b may automatically transmit such information to the control set analysis module 106d after determining the top entity combinations or control set(s) (e.g., in block 316).

As discussed previously, a value of the test set attribute of the one or more test set attributes may be the sum or total value of a specific attribute with respect to test entities within the test set. Likewise, a value of a combination attribute of the one or more combination attributes (e.g., combination attribute value) may be the sum or total value of a specific attribute with respect to control entities within a specific control set. In other embodiments, the information may also include values of the attribute over a time period (e.g., as specified by the user in FIG. 5A) in which each value corresponds to a point in time. In such case the control set analysis module 106d may determine multiple combination attributes (over a time period) for a specific attribute of the test set or control set.

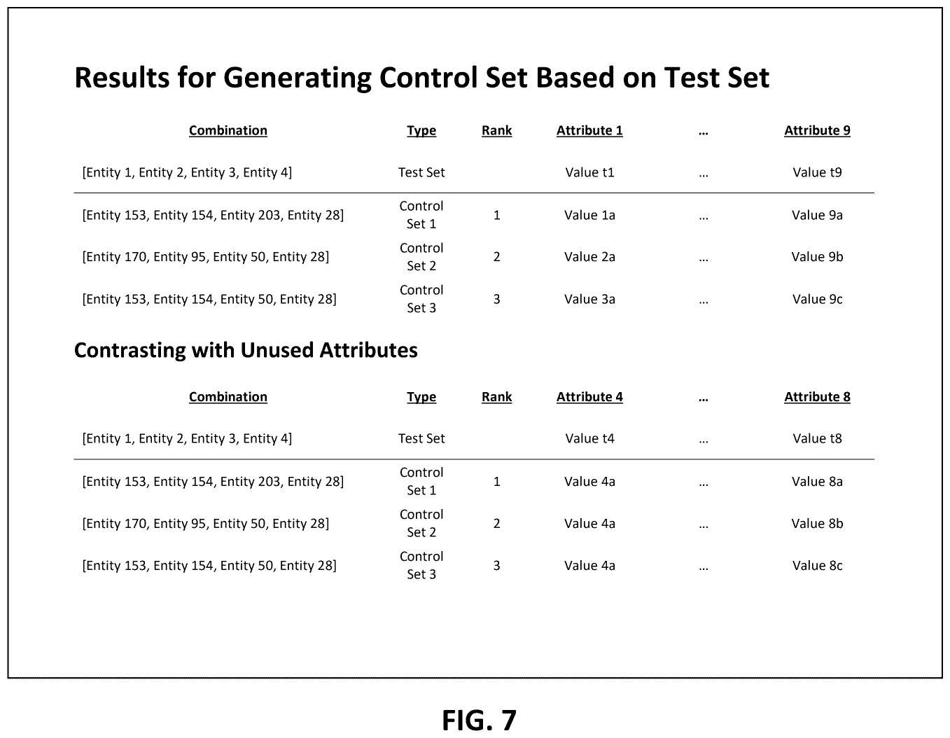

At block 320, the control set(s) and the analysis set are transmitted to a user interface. More specifically, the control set generating module 106b may transmit the control sets (e.g., including one or more of the top entity combinations) to the user interface module 106a, which in turn may transmit the control sets to be displayed before the user on the client computing device 102. An example of a user interface provided by the user interface module 106a (e.g., for display before the user) is shown in FIG. 7. As shown, the user interface includes a table indicating the test set and the control sets, as well as the entities that are included in the test set and each of the control sets. Further, the test set attribute (e.g., “Value t1”, “Value t9”) and the combination attributes (e.g., “Value 1a”, “Value 9b”) for each control set are also displayed before the user. As indicated previously with respect to the user interface shown in FIG. 5A, the user selected “Attributes 1-3, 6, 7, and 9” to determine the control sets. As such, the test set attributes and the combination attributes correspond to the attributes selected by the user. By displaying such information to the user, the user is capable of contrasting the differences between the test entity and each of the control sets.

It should also be noted that the user interface of FIG. 7 also displays attributes that the user had not selected to determine the control set (e.g., “Attributes 4, 5, and 8”). Similarly, the values associated with the unselected or unused attributes are also a total or sum of the attributes corresponding to each entity in the test set or entity combination. For example, the “Value t4” is the total (or sum) of the values of “Attribute 4” with respect to each entity in the test set. In another example, the “Value 4a” the total (or sum) of the values of “Attribute 4” with respect to each entity in “Control Set 1”. By displaying such information to the user, the user is capable of contrasting the differences between the test entity and each of the control sets with respect to unselected attributes.

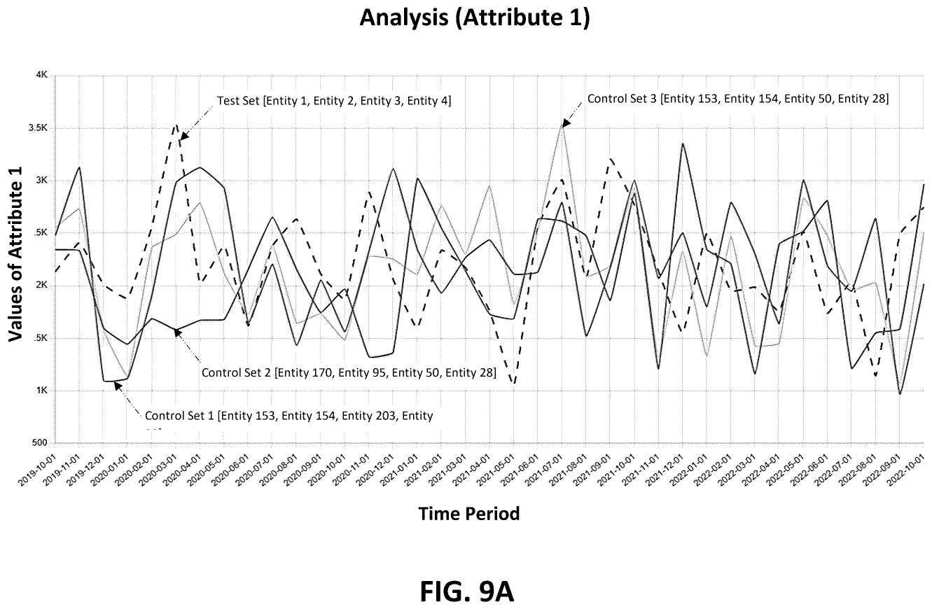

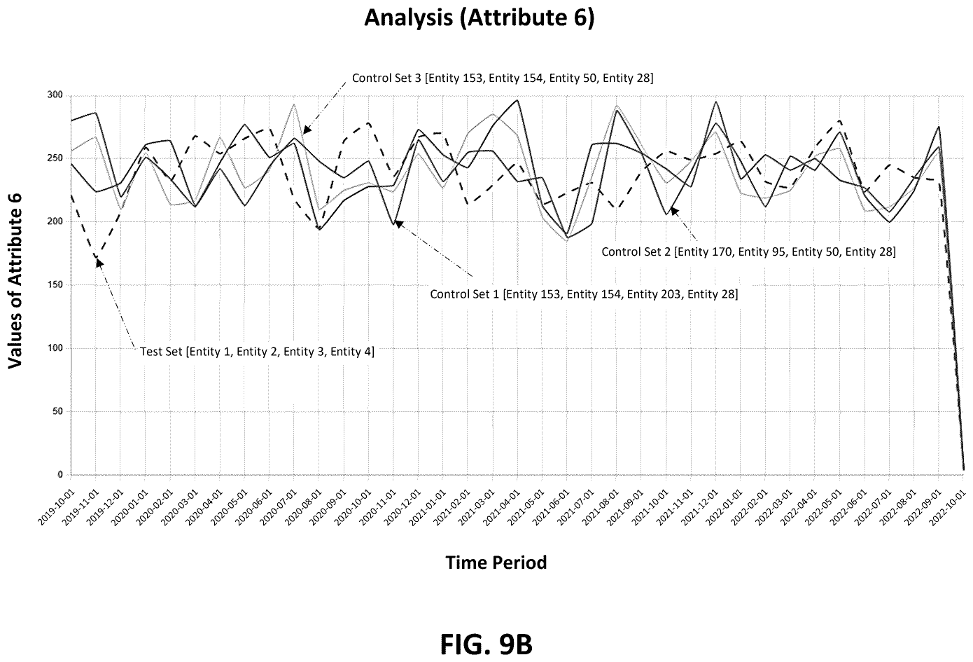

Likewise, the control set analysis module 106d may also transmit the analysis set include one or more graphical analyses to the user interface module 106a, which in turn may transmit the analysis set to be displayed before the user on the client computing device 102. FIG. 9A shows a graphical analysis of “Attribute 1” with respect to the “Test set” and “Control Sets 1-3) over a period of time (e.g., as set by the user in the user interface shown in FIG. 5A). Although FIG. 9A displays a line graph analysis, the graphical analysis may be in another format (e.g., bar graph, pie chart, scatter plot, column chart, etc.). As discussed above, there may be multiple combination attribute values for a specific attribute of the test set or control set (e.g., for each point in time). For example, as shown in FIG. 9A, there are many combination attribute values associated with “Attribute 1” (e.g., the combination attribute at the date “2019 Oct. 1” is “2.5 k” for “Control Set 1” and the combination attribute at the date “2021 Aug. 1” is “1.5 k” for “Control Set 1”). Further, the lines representing the test sets and control sets may be different from each other for better visual distinction (e.g., different in terms of color, line type, shape, size, etc.).

Likewise, FIG. 9B shows a graphical analysis of “Attribute 6” with respect to the “Test set” and “Control Sets 1-3) over a period of time (e.g., as set by the user in the user interface shown in FIG. 5A). Similar to FIG. 9A, the lines representing the test sets and control sets in FIG. 9B may be different from each other for better visual distinction (e.g., different in terms of color, line type, shape, size, etc.). In some embodiments, the graphical analyses illustrated in FIG. 9A and FIG. 9B are displayed simultaneously (e.g., side-by-side) on a user interface before the user. In other embodiments, the graphical analyses illustrated in FIG. 9A and FIG. 9B are displayed one at a time. By displaying the graphical analysis in the aforementioned manner, the user is capable of drawing conclusions regarding the amount of similarities or differences (or relationship) among the control sets and the test set in a visual manner. The routine ends at block 322.

It should be noted that an advantage of the one or more routines (or processed) recited in this disclosure is that such routines allows for the selection of a control set from a population size that is small (e.g., less than 300 or 500 entities), while allowing for better matching among the entities in the control set to the entities in the test set, which increases the sensitivity of the measurement in the experiment. In other words, not only does the routine 300 allow for selection of entities from a small population, but it also provides an improvement (over conventional methods, e.g., (k-) nearest neighbor matching, caliper matching, etc.) in selecting the entities in the control set that are most similar to the entities in the test set, thereby allowing for more accurate conclusions to be drawn from the experiment.

Further, the routine 300 is different from well-understood, routine, and conventional activity because the control set is generated using a multi-stage approach in which the routine 300 (a) determines the top entities that are most similar to test entities, (b) remove top entities that are determined to be duplicates, (c) generate entity combinations based on remaining top entities, and (d) determine top entity combinations (e.g., control sets). In contrast, the conventional methods (e.g., (k-) nearest neighbor matching, caliper matching, etc.) for selecting a control set includes determination at a single stage (i.e., find the members of the population that are closest to members of the test group based on a single calculation). As discussed above, the multi-stage approach allows for better selection the entities in the control set that are most similar to the entities in the test set, thereby allowing for more accurate conclusions to be drawn from the experiment.

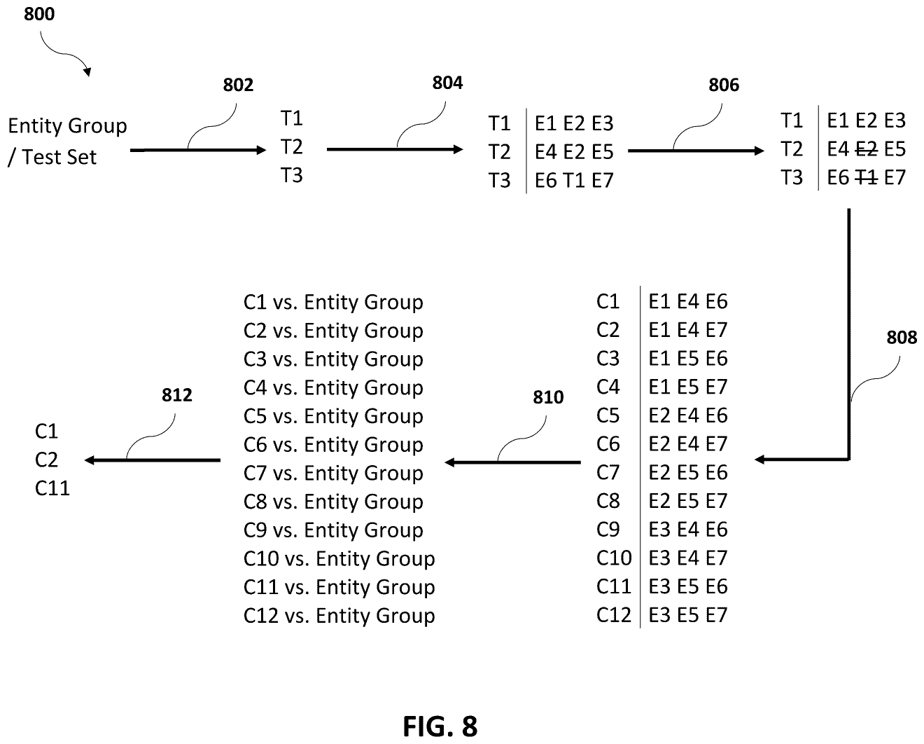

It should further be noted that the routine (or process) 300 in FIG. 3 is also illustrated in the stage flow diagram 800 of FIG. 8 (with slight modifications) that may be implemented in some embodiments. As shown, a user may be attempting to generate one or more control sets for a test set. For example, as shown previously in FIGS. 4A and 4B, the entity group may include one or more entities (e.g., “Entities 1-4”) of an entity unit. In some embodiments, the test set and the entity group include the same entities (as shown in FIG. 4A). In other embodiments, the test set may be a subset of the entity group (as shown in FIG. 4B). At stage 802, the entities (“T1”, “T2”, “T3”) in the entity group (or test set) are determined. At stage 804, a match set is generated for each entity in the entity group (or test set). For example, the match set corresponding to test entity “T1” includes entities “E1”, “E2”, and “E3”. More specifically, entities from the entity unit associated with the test entities may be retrieved from the entity database 108. Further, the entities in the match set may be determined using a entity score generated via equation (1) as discussed previously.

At stage 806, duplicate entities are removed from the match sets. For example, the entity “E2” appears in both the match set corresponding to test entity “T1” and test entity “T2”. As such, the entity “E2” is removed from the match set corresponding to test entity “T2”, but remains in the match set corresponding to test entity “T1”. In another example, the test entity “T2” is included in the match set corresponding to test entity “T3”. Since test entities cannot be included in the control set, the test entity “T2” is removed from the matchet corresponding to the test entity “T3”.

At stage 808, an entity combination is generated for each possible combination of entities in the match sets (e.g., entities “E1”, “E2”, “E3”, “E4”, “E5”, “E6”, and “E7”). For example, the entity combination “C1” includes entities “E1”, “E2”, and “E3”. It should be noted that, as discussed previously, such possible combination may include be a mathematical combination, in which the standard notation for such mathematical combination may be represented by C(n, k), ₙCₖ, or

$$( \begin{matrix}n \\ k\end{matrix} ) ,$$

wherein n is the total number of entities in the match set (e.g., entities “E1”, “E2”, “E3”, “E4”, “E5”, “E6”, and “E7”) and k is a predetermined number such as, for example, the maximum number of entities in a match set (e.g., before the duplicates are removed), another predetermined number that is predefined, or a number that is selected by a user via a user interface. At stage 810, a combination score is generated for each of the entity combinations (e.g., “C1”, “C2” “C12”) based on at least one of the entity group or the test set. For example, the combination score may be determined using equation (2) as discussed previously. At stage 812, a top predetermined number of entity combinations (e.g., entity combinations with the lowest scores) are determined to be the control set (e.g., “C1”, “C2”, “C11”).

### Execution Environment

FIG. 10 illustrates various components of an example computing device 1000 configured to implement various functionality described herein.

In some embodiments, the computing device 1000 may be implemented using any of a variety of computing devices, such as server computing devices, desktop computing devices, personal computing devices, mobile computing devices, mainframe computing devices, midrange computing devices, host computing devise, or some combination thereof.

In some embodiments, the features and services provide by the computing device 1000 may be implemented as webs services consumable via one or more communication networks. In further embodiments, the computing device 1000 is provided by one or more virtual machines implemented in a hosted computing environment. The hosted computing environment may include one or more rapidly provisioned and released computing resources such as computing devices, networking devices, and/or storage devices. A hosted computing environment may also be referred to as a “cloud” computing environment.

In some embodiments, as shown, a computing device 1000 may include one or more processors 1002, such as physical central processing units (“CPUs”); one or more network interfaces 1004, such as network interface cards (“NICs”); one or more computer readable medium drives 1006, such as a high density disk (“HDDs”), solid state drives (“SSDs”), flash drives, and/or other persistent computer readable media; one or more input/output drive interfaces 1008; and one or more computer-readable memories 1010, such as random access memory (“RAM”) and/or other volatile non-transitory readable media.

The one or more computer-readable memories 1010 may include computer program instructions that one or more computer processors 1002 execute and/or data that the one or more computer processors 1002 use in order to implement one or more embodiment. For example, the one or more computer-readable memories 1010 can store an operating system 1012 to provide general administration of the computing device 1000. As another example, the one or more computer-readable memories 1010 can store a user interface module 1014 (user interface module 106a) for interacting with a user using a client computing device 102. In a further example, the one or more computer-readable memories 1010 can store a control set generating module 1016 (e.g., control set generating module 106b) for generating one or more control sets based on a test set. In yet another example, the one or more computer-readable memories 1010 can store an entity retrieval module 1018 (e.g., entity retrieval module 106c) for retrieving entities from a database (e.g., entity database 108). In yet a further example, the one or more computer-readable memories 1010 can store a control set analysis module 1010, which generates a graphical analysis of the test set and corresponding control sets.

### Terminology

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus (e.g., a programmable processor, a computer, and/or multiple computers). A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry (e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like). Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data (e.g., magnetic, magneto-optical disks, or optical disks). A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices (e.g., DRAM, SRAM, EPROM, EEPROM, and flash memory devices); magnetic disks (e.g., internal hard disks or removable disks); magneto-optical disks; and optical disks (e.g., CD, DVD, HD-DVD, and Blu-ray disks). The processor and the memory can be supplemented by and/or incorporated in special purpose logic circuitry.

To provide for interaction with a user, the above-described techniques can be implemented on a computing device in communication with a display device (e.g., a CRT (cathode ray tube), plasma, or LCD (liquid crystal display) monitor, a mobile device display or screen, a holographic device and/or projector, for displaying information to the user and a keyboard and a pointing device (e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback (e.g., visual feedback, auditory feedback, or tactile feedback; and input from the user can be received in any form, including acoustic, speech, and/or tactile input).

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computing (or computer) system for improving the selection of one or more control sets based on a test set, the system comprising a server computing device having a memory for storing computer-executable instructions and a processor that executes the computer-executable instructions to:
retrieve entities associated with an entity unit after receiving instructions to generate the one or more control sets based on the test set, wherein the test set includes one or more test entities that correspond to respective entities in the entity unit;
determine one or more match sets for the test entities in the test set, wherein each match set includes a predetermined number of entities in the entity unit that are determined to be most similar to a corresponding test entity, the determination of a match set for each test entity comprising:
generating an entity score for each entity in the entity unit, wherein the entity score is generated based on entity attributes associated with the entity and test attributes associated with the test entity; and
generating the match set based on predetermined number of entities that have leading entity scores;
remove entities in each of the match set that correspond to a test entity in the test set and that are duplicates of entities in other match sets, such that the one or more match sets includes entities that are unique;
generate one or more entity combinations based on the entities in the one or more match sets, wherein the one or more entity combinations include one or more possible combinations of the entities in the one or more match sets;
generate a combination score for each entity combination, wherein each combination score is generated based on combination attributes associated with the entity combination and test set attributes associated with the test entity;
generate the one or more control sets based on predetermined number of entities that have leading combination scores; and
display, on a user interface, the one or more control sets including the entities that are included in each of the one or more control sets.

2. The system of claim 1, wherein the instructions to generate the one or more control sets based on the test set are provided by a user via a user interface that is configured to receive instructions to customize the generating of a control set based on one or more selections by the user.

3. The system of claim 2, wherein the user interface is configured to allow a user to select one or more attributes corresponding to each of the one or more entities, and wherein selected attributes are utilized in determining the entities to be included in the one or more control sets and unselected attribute are not utilized in determining the entities to be included in the one or more control sets.

4. The system of claim 3, wherein the user interface is configured to allow a user to determine an attribute importance level with respect to each selected attribute, the attribute importance level determining the weight that the corresponding attribute has on determining the entities to be included in the one or more control sets.

5. The system of claim 2, wherein the user interface is configured to allow a user to select a time period in connection with the one or more attributes, and wherein a value corresponding to each of the one or more attributes is an average value generated based on the time period.

6. The system of claim 2, wherein the user interface is configured to allow a user to select one or more filters, and wherein each of the one or more filters removes one or more entities from the entity unit that violate criteria corresponding to the filters.

7. The system of claim 2, wherein the user interface is configured to allow a user to select the number of control sets to generate based on the test set.

8. A non-transitory computer-readable medium including computer-executable instructions that, when executed by a computing device, causes the computing device to:
retrieve entities associated with an entity unit after receiving instructions to generate one or more control sets based on a test set, wherein the test set includes one or more test entities that correspond to respective entities in the entity unit;
determine one or more match sets for the test entities in the test set, wherein each match set includes a predetermined number of entities in the entity unit that are determined to be most similar to a corresponding test entity, the determination of a match set for each test entity comprising:
generating an entity score for each entity in the entity unit, wherein the entity score is generated based on entity attributes associated with the entity and test attributes associated with the test entity; and
generating the match set based on predetermined number of entities that have leading entity scores;
remove entities in each of the match set that correspond to a test entity in the test set and that are duplicates of entities in other match sets, such that the one or more match sets includes entities that are unique;
generate one or more entity combinations based on the entities in the one or more match sets, wherein the one or more entity combinations include one or more possible combinations of the entities in the one or more match sets;
generate a combination score for each entity combination, wherein each combination score is generated based on combination attributes associated with the entity combination and test set attributes associated with the test entity;
generate the one or more control sets based on a predetermined number of entities that have leading combination scores; and
display, on a user interface, the one or more control sets including the entities that are included in each of the control sets.

9. The non-transitory computer-readable medium of claim 8, wherein the entity score is determined based at least in part on selected attributes, which are attributes that are utilized in determining the one or more control sets.

10. The non-transitory computer-readable medium of claim 9, wherein the entity score is represented by the following equation:
$$entity score = {\sum }_{k = 1}^{n} attribute {{weight}_{k} ( \frac{test {attribute}_{k}}{entity {attribute}_{k}} - 1 )}^{2}$$
where n represents the number of selected attributes.

11. The non-transitory computer-readable medium of claim 10, wherein the entities in the entity unit are arranged based on their respective entity scores, in which a predetermined number of entities having the lowest entity scores are included in a match set.

12. The non-transitory computer-readable medium of claim 8, wherein the combination score is determined based at least in part on selected attributes, which are attributes that are utilized in determining the one or more control sets.

13. The non-transitory computer-readable medium of claim 12, wherein the source urgency value is represented by the following equation:
$$combination score = {\sum }_{k = 1}^{n} attribute {{weight}_{k} ( \frac{test set {attribute}_{k}}{combination {attribute}_{k}} - 1 )}^{2}$$
where n represents the number of selected attributes.

14. The non-transitory computer-readable medium of claim 13, wherein the one or more entity combinations are arranged based on their respective combination scores, in which a predetermined number of entity combinations having the lowest combination scores are included in a control set.

15. A computerized method for validating the qualifications of an entity to prevent fraud, the method comprising:
retrieving entities associated with an entity unit after receiving instructions to generate the one or more control sets based on the test set, wherein the test set includes one or more test entities that correspond to respective entities in the entity unit;
determining one or more match sets for the test entities in the test set, wherein each match set includes a predetermined number of entities in the entity unit that are determined to be most similar to a corresponding test entity, the determination of a match set for each test entity comprising:
generating an entity score for each entity in the entity unit, wherein the entity score is generated based on entity attributes associated with the entity and test attributes associated with the test entity; and
generating the match set based on predetermined number of entities that have leading entity scores;
removing entities in each of the match set that correspond to a test entity in the test set and that are duplicates of entities in other match sets, such that the one or more match sets includes entities that are unique;
generating one or more entity combinations based on the entities in the one or more match sets, wherein the one or more entity combinations include one or more possible combinations of the entities in the one or more match sets;
generating a combination score for each entity combination, wherein each combination score is generated based on combination attributes associated with the entity combination and test set attributes associated with the test entity;
generating the one or more control sets based on predetermined number of entities that have leading combination scores; and
displaying, on a user interface, the one or more control sets including the entities that are included in each of the one or more control sets.

16. The method of claim 15, wherein each control set of the one or more control sets is associated with control set attributes, each control set attribute of a control set being associated with one or more control set attribute values that correspond to one or more points in time.

17. The method of claim 16, wherein each test set attribute is associated with one or more test set attribute values that correspond to the one or more points in time, and wherein each test set attribute corresponds to a respective control set attribute.

18. The method of claim 17, further comprising:
generating an analysis set that includes a graphical analysis for each attribute that corresponds to a test set attribute and a control set attribute, wherein the analysis set is generated based on the test set attributes and the control set attributes, and wherein a graphical analysis of a specific attribute visually indicates the control set attribute values and the test set attribute values over a time period associated with the one or more points in time.

19. The method of claim 18, further comprising:
displaying one or more graphical analyses in the analysis set.

20. The method of claim 19, wherein the graphical analysis is at least one of a line graph, a bar chart, a pie chart, and a scatter plot.
